(19) United States
(12) Patent Application Publication
(10) Pub. No.: US 2002/0166497 A1
(43) Pub. Date: Nov. 14, 2002

(54) Reference bookmark

(76) Inventor: Jean-Marc Rae, Sacramento, CA (US)

Correspondence Address: JEAN-MARC RAE, 2724 ELVYRA WAY, APT. 46, SACRAMENTO, CA, 95821, US

(21) Appl. No.: 09/854,091

(22) Filed: May 11, 2001

(51) Int. Cl. B42D 9/00

(52) U.S. Cl. 116/237; 116/234; 281/42

(57) ABSTRACT

A reference bookmark, which by shape and proportion clenches a page of a book and which identifies the page and the text last read using a display window with a fully adhesive label. The invention is a rigid-planar device comprising a display window 1, a marker 2 and a stabilizer 3.The display window 1 is an extension of the marker 2. The reader places a fully adhesive label within the perimeter of the display window 1 and inscribes a personal note pertinent to the text of the marked page, for future referral. The display window 1 clears the page margin, enabling the reader to view and consult his notes, whether the book remains open or shut, thereby relocating the desired text or subject matter of the marked page. An opening between the marker 2 and the stabilizer 3 elements allows the bookmark to admit the clenched pages.

### FIELD OF THE INVENTION

The present invention is an advancement in the field of bookmarks with particular reference to those bookmarks that are capable of directing a reader to a specific text and page of a book.

### PRIOR ART

In the past bookmarks were manufactured from ribbon, cloth, leather, cardboard, and metals. These have been planar devices, usually made in a rectangular shape. These traditional bookmarks are only suitable for marking the reader's position from one reading session to the next. Hoffman Jr., U.S. Pat. No. 4,793,632, Dec.27, 1988 has added an automatic feature to the bookmark, which records the reader's last page turned, but his invention is complicated and expensive to manufacture. Another example is to be found in U.S. Pat. No. 5,577,459, Nov.26,1996, where William Alden utilizes an imprinted, encircling indicator band that slides vertically about the body. Each of the foregoing has as its objective the location of a page, and a specific line or text of a book by means of a movable indicating device, which are subject to misplacement or misalignment due to jarring or other disturbance. One clip bookmark manufactured by Lindsay Claire of Niagara Falls, N.Y., for one, almost got it right. The problem with this bookmark is that it does not facilitate setting the bookmark for future referral, due to the pewter decoration.

There therefore now exists a need for an improved bookmark that is not subject to misplacement due to problems attendant to the handling of the book in which it is placed. This bookmark points to a particular physical embodiment. The implementation of a display window that is highly resistant to the environmental influences that would prompt other devices to give false indications of the text selected.

### SUMMARY OF THE INVENTION

The present invention relates to specialized bookmarks that are capable of identifying not only the last page read, but also providing elements that direct the user to a particular text of a book. This bookmark simply and accurately indicates a previously selected text whether the book remains open or closed, by utilizing a display window element. This is a novel bookmark, incorporating a display window, with adhesive label for personal inscription by the reader pertaining to the desired text of a marked page of a book, for future referral. The display window remains outside of the page margins of a book, as an extension to the marker, when this invention is in use as intended.

The bookmark can clench a single page or a sheaf of pages securely due to the arrangement of the elements, thereby providing a high degree of reliability in retaining the page and desired portion of text for future referral. The bookmark is a planar device made from one piece of sheet material which makes it simple to utilize and economical to manufacture. It has large flat areas that are suitable for advertising indicia and personal decoration, offering lasting appeal. One skilled in the art of manufacturing bookmarks may devise other suitable shapes for this invention.

### BRIEF DESCRIPTION OF THE DRAWINGS

FIG. 1 shows my bookmark as a symmetrical embodiment.

FIG. 2 shows Prior Art, a simple clip bookmark with pewter decoration, manufactured by Lindsay Claire of Niagara Falls, N.Y., for one.

FIG. 3 shows the bookmark set in an open book clenching a page, with the display window remaining outside of the page margin.

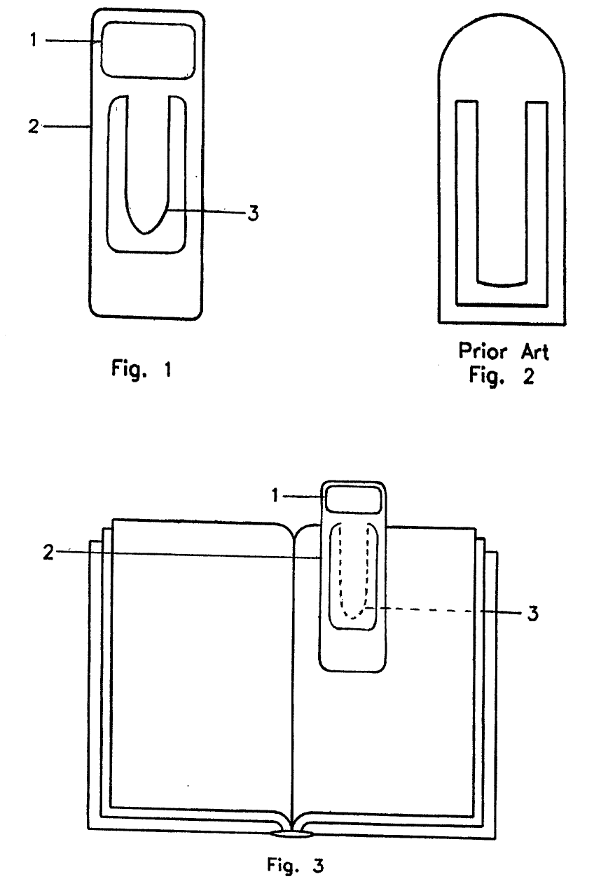

### DRAWING REFERENCE NUMERALS

1—A display window element

2—A marker element

3—A stabilizer element

### DESCRIPTION OF THE PREFERRED EMBODIMENT

This reference bookmark in its preferred embodiment is a bookmark with a display window capable of accurately identifying a page, and a text or subject matter of a book. The book may remain open or shut. The bookmark comprises of at least three elements. These elements are a display window 1, a marker 2, and a stabilizer 3. The display window 1 remains beyond the page margin of the book as an extension of the marker 2, and should have a flat area large enough to contain a fully adhesive label, but not so large as to be inconvenient when extended from the page margin of the page-marked book. When the bookmark is in use as intended, the marker 2 is placed on the front of a page and the stabilizer 3 on the obverse or back side of the page as illustrated in FIG. 3.

The reader places a blank, fully adhesive label within the perimeter of the display window 1 and inscribes relevant notes pertinent to a desired text or subject matter on the marked page. By viewing and referring to his notes the reader is able to simply relocate the desired text on the marked page whether the book remains open or closed. For a change of desired text, the reader replaces the previously inscribed label with a blank label, for further inscription pertaining to the newly desired text. A high degree of reliability is achieved in retaining the desired text and marked page, for future referral. The clenching action of the marker 2 and the stabilizer 3 provides a more secure placement of the bookmark than is obtained with a simple rectangular bookmark. At this point it should be understood that one skilled in the art of manufacturing bookmarks may select the exact proportion between the marker 2 and the stabilizer 3.The opening between the marker 2 and the stabilizer 3 allows entrance to the pages clenched by the set reference bookmark.

The bookmark of my invention is a planar device manufactured from a stiff and bendable lightweight material such as sheet plastic or sheet metal that may have a symmetrical or an asymmetrical embodiment. The surfaces of my bookmark should be smooth so that contact with pages of a book will not damage or mark those pages.

I claim:

1. A bookmark that comprises of at least three elements;
a. a display window 1
b. a marker 2
c. a stabilizer 3
and where:
said display window 1 consisting of a generally flat body having a first side and a second side opposite the first side, said body having a perimeter including a first edge, a second edge opposite the first edge, a third edge extending between the first and second edges, and a fourth edge opposite the third edge and extending between the first and second edges, said display window 1 disposed upon said marker 2 and always remaining beyond a page margin of a book when each of said marker 2 and said stabilizer 3 are positioned on the front and back sides of a page, so that the page is between said marker 2 and said stabilizer 3,
and said marker 2 is as long as the distance that said marker 2 can project into the margin of a page of a book, when said marker 2 is on the top of a page and said stabilizer 3 is on the bottom or obverse side of the page, so that said marker 2 and said stabilizer 3 are clenching a page, and said marker 2 is more than one centimeter longer than said stabilizer 3,
and said stabilizer 3 is more than one centimeter long and the length of said stabilizer 3 is determined by measuring from the edge of a clenched page to the furthest point from the page margin, when said marker 2 remains on the top of a page and said stabilizer 3 is on the bottom or obverse side of the page,
and said bookmark is a rigid planar or semi-rigid planar object and is the means to mark a page and text of interest in a book, magazine, or manual, to a reader, and said bookmark clenches a page by a wedging or flexing action of said elements.
